(19) United States
(12) Patent Application Publication
(10) Pub. No.: US 2004/0088456 A1
(43) Pub. Date: May 6, 2004

(54) Smart hard-disk drive

(76) Inventor: Guobiao Zhang, Stateline, NV (US)

Correspondence Address: Guobiao Zhang, P.O. Box 6182, Stateline, NV, 89449-6182, US

(21) Appl. No.: 10/685,887

(22) Filed: Oct. 14, 2003

Related U.S. Application Data
(60) Provisional application No. 60/433,235, filed on Dec. 13, 2002.
(60) Provisional application No. 60/436,292, filed on Dec. 24, 2002.

(30) Foreign Application Priority Data
Oct. 22, 2002 (CN) 02133943.0

(51) Int. Cl. G06F 13/12; G06F 13/38

(52) U.S. Cl. 710/74

(57) ABSTRACT

The present invention provides a smart hard-disk drive (sHDD). It can act as a host and directly communicate with multimedia devices. The sHDD offers true portability and provides a universal multimedia exchange platform (i.e. communicating directly with digital camera, mp3 player, camcorder, movie-playing device, etc.) The HDD integration breaks the traditional design barrier by integrating at least a portion of the HDD electronics onto the system motherboard.

### CROSS-REFERENCE TO RELATED APPLICATIONS

This patent application relates to the following domestic patent applications:

1. “Smart Hard-Disk Drive”, provisional application Ser. No. 60/433,235, filed on Dec. 13, 1902;

2. “Smart Hard-Disk Drive”, provisional application Ser. No. 60/436,292, filed on Dec. 24, 1902;

and the following foreign patent applications:

1. “Smart Hard-Disk Drive”, CHINA P. R., patent application Ser. No. 02133943.0, filed on Oct. 22, 1902;

all by the same inventor.

### BACKGROUND

### 1. TECHNICAL FIELD OF THE INVENTION

The present invention relates to the field of information storage systems, and more particularly to hard-disk drive.

### 2. PRIOR ARTS

Today, digital multimedia devices (4 in FIG. 1A) are quickly gaining popularity. They can be categorized into digital recording devices and digital content players. Digital recording devices include digital voice recorder, digital camera (4c in FIG. 1A), digital camcorder, etc. Digital content players include digital music players (e.g. MP3 player 4p in FIG. 1A), digital movie player (e.g. VCD player or DVD player), etc. At present, these devices typically use flash cards, digital tapes or optical disks to store the acquired information or pre-recorded contents. These storage means have various drawbacks: flash cards are expensive; digital tapes lack random accessibility; and all of these storage means have limited capacity. Moreover, the variety of storage means makes data exchange between devices difficult. Ideally, a multimedia storage device should have the following attributes: 1. portability (i.e. light-weighted and palm-sized); 2. large capacity under a reasonable price (e.g. ˜GB under $200); 3. versatility (i.e. a universal multimedia exchange platform).

Recently, hard-disk drive (HDD) is undergoing significant improvements. One HDD product of particularly interest is portable HDD (pHDD). It is, in fact, an USB-based HDD, i.e. its external interface is the USB interface 5u. Referring to the cross-sectional view of FIG. 1C and the plan view of FIG. 1D, the pHDD 6 is an enclosure 16 that houses a conventional off-the-shelf HDD 15. Because the off-the-shelf HDD 15 is based on the IDE (ATA) interface 15m, it needs to be converted into the USB interface 5u by an IDE-to-USB bridge chip 621U. This bridge chip 621U is located on an extra conversion printed-circuit board (PCB) 82 (referring to the PCB layout of FIG. 1D and the block diagram of FIG. 1E).

The pHDD offers great user-convenience. Between office and home, the user only needs to carry a pHDD instead of a notebook computer (assuming there is at least one computer in the office and at home). As of late 2002, a pHDD can hold up to 40 GB data. It has a size of 120 mm(L)×70 mm(W)×10 mm(T) (FIG. 1B) and a weight of ˜120 g. Its retail price is ˜$100 for the 30 GB model.

At the first glance, the pHDD 6 seems to be a good candidate for the multimedia storage. Unfortunately, it is a “dumb” (or passive) device: it cannot directly communicate with a multimedia device 4, but needs a host computer (e.g. a notebook computer 2) to act as an intermediary FIG. 1A). A notebook computer 2 is heavy (weight>6 lb, including casing and power) and bulky (briefcase-sized). Accordingly, the pHDD does not offer true portability. The present invention provides a smart hard-disk drive (sHDD). An sHDD has all desired attributes of the multimedia storage.

### OBJECTS AND ADVANTAGES

It is a principle object of the present invention to provide a multimedia storage with true portability;

It is a further object of the present invention to provide a multimedia storage with a large capacity;

It is a further object of the present invention to provide a multimedia storage with a low cost.

It is a further object of the present invention to provide a universal multimedia exchange platform.

It is a further object of the present invention to provide a digital camcorder with greater user-convenience.

It is a further object of the present invention to provide a movie-playing apparatus between a hard-drive and a TV.

In accordance with these and other objects of the present invention, a smart hard-disk drive (sHDD) is disclosed.

### SUMMARY OF THE INVENTION

The present invention provides a smart hard-disk drive (sHDD). It can be used as a storage base for multimedia data. A user can directly download data (e.g. acquired image files) to the sHDD, or upload data (e.g. pre-recorded music files) from the sHDD. Unlike the pHDD that needs a host computer to intermediate the data transfer, an sHDD can act as a host and directly communicate with a multimedia device. Accordingly, the sHDD offers true portability.

The vast majority of the multimedia devices in commercial use are based on the USB interface. To become backward compatible with these devices, the sHDD preferably can support at least USB host function (more particularly, USB 1.1). On the other hand, when it is connected with a host computer, the sHDD can act as a peripheral. It preferably can support USB and/or IEEE 1394 and/or other interface protocols. Accordingly, the sHDD acts as a dual-role device. With the advent of the USB On-the-Go (JSB OTG) technology, this task can be easily accomplished. An USB host/slave controller can be used in an sHDD to switch its role from a host to a slave and vice versa.

When making the HDD-based systems, the conventional system manufacturer follows a compartmentalized model: the design of the HDD electronics is the responsibility of the HDD vendor (these HDD electronics are located on an HDD printed-circuit board, which is sealed inside an off-the-shelf HDD “box”); the design of the system electronics is the responsibility of the system manufacturer (these system electronics are located on a system motherboard, which communicates with the HDD through the IDE interface. From the system manufacturer's perspective, the off-the-shelf HDD is a “black box”). This system partition originated from the computer age. Because size and cost are critical in a portable system, this design and business model is not quite suitable for an HDD-based portable system

The present invention breaks the traditional design barrier and discloses a new design and business model—HDD integration. According to the HDD integration, at least a portion of the HDD electronics are integrated onto the system motherboard. The savings from the HDD integration (including at least one PCB and two IDE connectors) reduce the system size and lower the bill-of-materials. Moreover, with the HDD integration, more resources (e.g. μprocessor, memory) can be shared between the HDD electronics and system functions. The HDD integration can be extended to other HDD-based systems, e.g. HDD-based personal digital assistance (HDD-PDA).

One design philosophy of the sHDD is to make it simple. Instead of making it a computer-like device (which can cost ˜$500+ and can hardly be put into a pocket), preferably only bare-bone host function is designed in. This will result in a low-cost and reasonably sized sHDD. Accordingly, the present invention discloses a hybrid sHDD. It can utilize the battery, control and/or display of the multimedia device. One type of the hybrid sHDD—peripheral-powered sHDD—can be powered by the battery of the multimedia device. It is significantly lighter and smaller than a self-powered sHDD. Another type of the hybrid sHDD—screen-less SUDD—uses the display of the multimedia device to show the directory information.

The sHDD provides a universal multimedia exchange platform. At present, a user needs to buy a number of storage media for all types of the multimedia devices the owns: one set of flash cards for the digital camera, digital tapes for the digital camcorder, another set of flash cards for the MP3 player, DVD's for the DVD player. With the advent of the sHDD, a single sHDD is all that needed. It can be used to store all multimedia data needed by various types of multimedia devices, e.g. digital voice from a digital voice recorder, digital photos from a digital camera, digital videos from a digital camcorder, pre-recorded music for a MP3 player, pre-recorded movie for a DVD player. A universal multimedia exchange platform offers excellent user-convenience and also lowers the total storage cost.

The present invention also discloses a compact HDD. It fully utilizes the empty space between the HDD's platter and voice-coil motor (referring to FIG. 11A). This space can be utilized to house HDD electronics, retractable wire, and/or battery.

An HDD can be used to store digital videos (including captured movies from a digital camcorder or pre-recorded movies for a movie player). A 40 GB HDD can hold up to 20 hours of DVD-quality video, which is equivalent to the contents carried by 20 tapes or 10 DVD's. Moreover, the random accessibility of the HDD can greatly simplify the video-editing process. The present invention discloses an HDD-based camcorder. It does not comprise a tape-drive but comprises (or can be connected with) an HDD. Accordingly, the video images are not stored in tapes or compact discs, but directly into the HDD (maybe through some buffer memory). The present invention also discloses a movie-playing apparatus. It converts the movie data from the HDD to the TV audio/video (A/V) signals and feeds them into a TV. Accordingly, a user can watch pre-recorded movies on a TV in a hotel room during travel.

The HDD consumes relatively large power. To reduce the power consumption, the present invention discloses two methods: one is intermittent HDD; the other is dual-speed HDD. For the intermittent HDD, preferably there is a buffer memory, either in the multimedia device or in the HDD. Only when this buffer memory is filled up will its contents be transferred to the HDD. Accordingly, this data transfer is an intermittent process. The HDD spends less time in read/write and consumes less power.

Alternatively, a dual-speed HDD can be used to reduce power consumption. The dual-speed HDD can spin at two speeds: high speed and low speed. When the data rate is small (e.g. the HDD uses USB 1.1 mode, or, stores/plays-back videos), the HDD only needs to spin at low speed. When it switches to USB 2.0 or IEEE 1394 modes, the HDD will spin at high speed.

### BRIEF DESCRIPTION OF THE DRAWINGS

FIG. 1A illustrates a usage model for a portable HDD (pHDD); FIG. 1B is a perspective view of the pHDD with its front panel pulled out; FIG. 1C is a cross-sectional view of the pHDD in the y-z plane across the HDD rotor; FIG. 1D is a plan view of the pHDD with its top cover removed and front panel pulled out; FIG. 1E is a block diagram of the HDD PCB and the interface-conversion PCB in the pHDD.

FIG. 2A illustrates a usage model for a preferred smart HDD (sHDD) during communication with a multimedia device; FIG. 2B is a perspective view of the preferred sHDD; FIG. 2C illustrates a usage model for the preferred sHDD during communication with a host computer.

FIGS. 3AA-3AB illustrate a first preferred discrete sHDD with discrete IC's; FIGS. 3BA-3BB illustrates a second preferred discrete sHDD with an integrated host/slave interface controller; FIG. 3CA illustrates a third preferred discrete sHDD with a first preferred separate host/slave data-path; FIG. 3CB illustrates a fourth preferred discrete sHDD with a second preferred separate host/slave data-path.

FIG. 4A is a block diagram of a first preferred integrated sHDD PCB; FIG. 4B is a block diagram of a second preferred integrated sHDD PCB; FIG. 4C is a detailed block diagram of the host/slave disk controller used in the second preferred integrated sHDD PCB; FIG. 4D is a preferred layout of the second preferred integrated sHDD PCB; FIG. 4E is a cross-sectional view of a preferred integrated sHDD in the y-z plane; FIG. 4F is a plan view of the preferred integrated sHDD with its top cover removed.

FIG. 5A is a block diagram of the motherboard of a preferred HDD-based PDA (HDD-PDA); FIG. 5B is a preferred motherboard layout; FIG. 5C is a perspective view of the preferred HDD-PDA; FIG. 5D is a cross-sectional view of the preferred HDD-PDA in the y-z plane.

FIG. 6AA illustrates a preferred connection between a multimedia device and a preferred peripheral-powered sHDD (P²-sHDD); FIG. 6AB is the block diagram of a preferred P²-sHDD motherboard; FIG. 6B illustrates an alternate preferred USB port on a multimedia device; FIG. 6C is a cross-sectional view of the preferred P²-sHDD in the y-z plane; FIG. 6D is a plan view of the preferred P2-sHDD with its top cover removed.

FIG. 7A illustrates a preferred directory structure at the sHDD root level; FIG. 7B illustrates a preferred music directory structure.

FIGS. 8A-8C illustrate three preferred controls on the sHDD front panel.

FIG. 9A illustrates a preferred download process; FIG. 9B illustrates a preferred upload process;

FIG. 9C illustrates a preferred information display process for a screen-less sHDD.

FIG. 10A illustrates a first preferred sHDD with dual host/slave receptacles; FIGS. 10BA-10BC illustrate a second preferred sHDD with a hybrid receptacle; FIGS. 10CA-10CB illustrate a third preferred sHDD with a hybrid type-B plug; FIG. 10CC is a preferred type-B-to-type-A adapter.

FIG. 11A illustrates a prior-art head-disk assembly (HDA); FIG. 11B illustrates a preferred compact HDD with an L-shaped HDA shell; FIGS. 11C-11EB illustrate several preferred components that can be located in the open space of the L-shaped shell; FIG. 11F illustrates an alternate preferred compact HDD.

FIGS. 12A-12C illustrate a preferred HDD-based camcorder.

FIGS. 13A-13B illustrate a preferred movie-playing apparatus.

FIG. 14A illustrates a preferred power-saving technique based on intermittent HDD; FIGS. 14BA-14BB illustrate two preferred locations of the buffer memory in two preferred dual-role interface PCB's; FIG. 14C illustrates a preferred location of the buffer memory in a preferred HDD-based camcorder; FIG. 14D illustrates a preferred location of the buffer memory in a preferred movie-playing apparatus; FIGS. 14EA-14EB illustrate a preferred DRAM card.

FIG. 15 illustrates a preferred implementation of a dual-speed HDD.

FIG. 16 compares the dimension and weight of various preferred sHDD's according to the present invention.

FIG. 17 illustrates a preferred host apparatus and its connections with a passive HDD and a multimedia device.

FIG. 18 is a preferred implementation of a host apparatus.

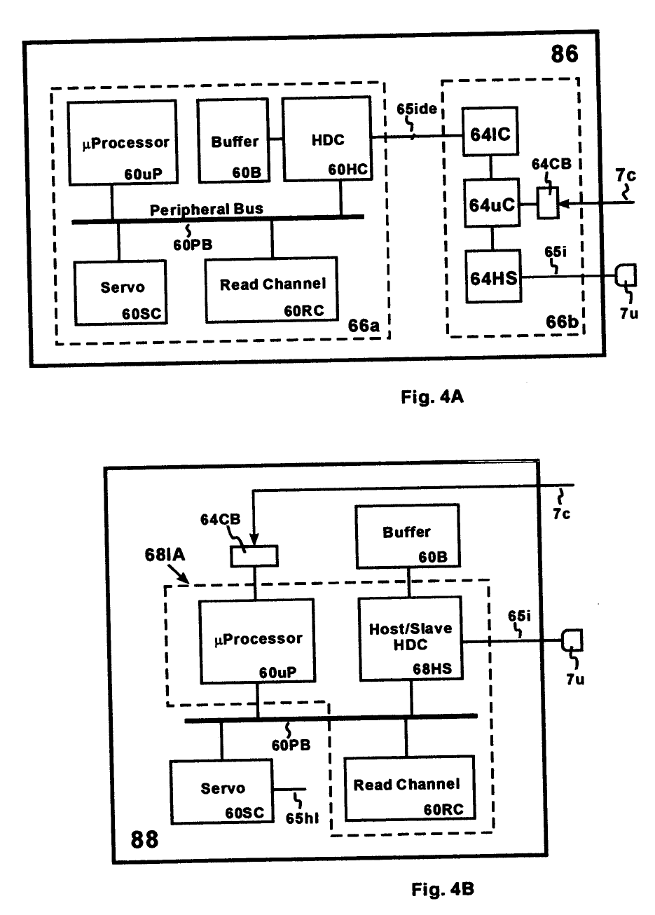

For the reason of simplicity, in this disclosure, the figure number with a missing appendix refers to all figures with that appendix. For example, FIG. 6 refers to FIGS. 6AA-6D; and FIG. 6A refers to FIGS. 6AA-6AB.

### DETAILED DESCRIPTION OF THE PREFERRED EMBODIMENT

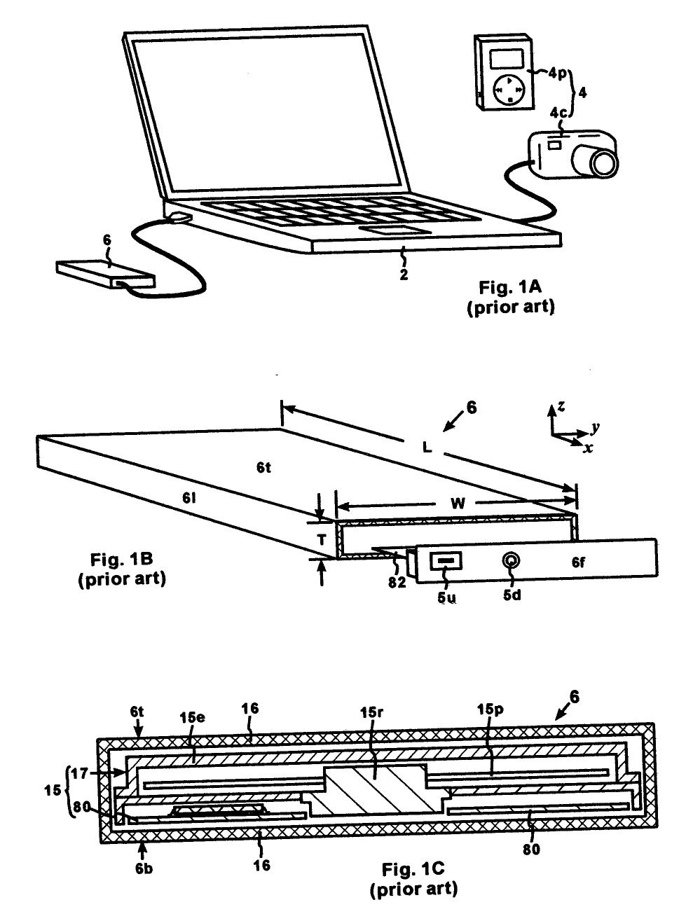

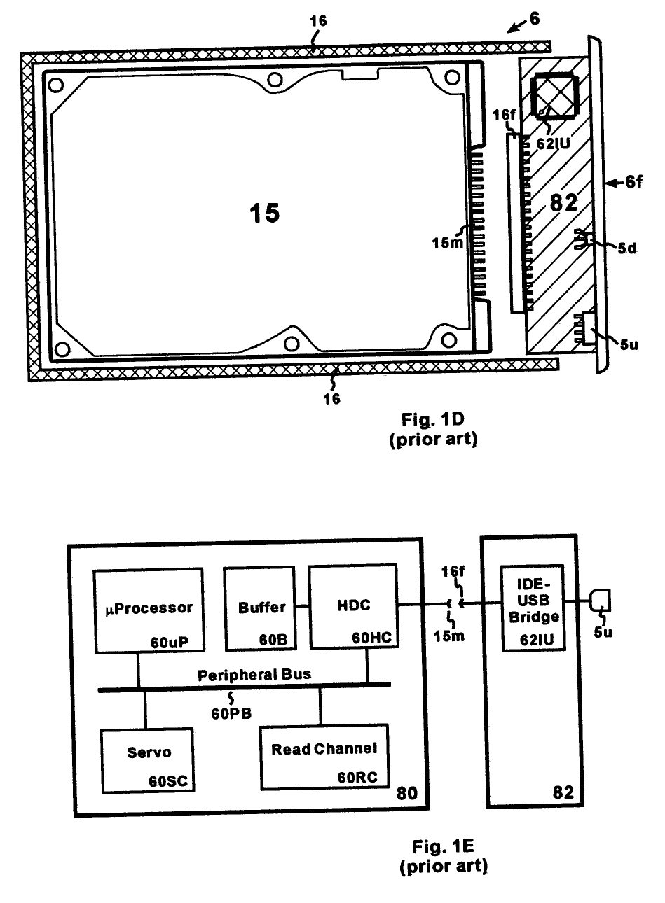

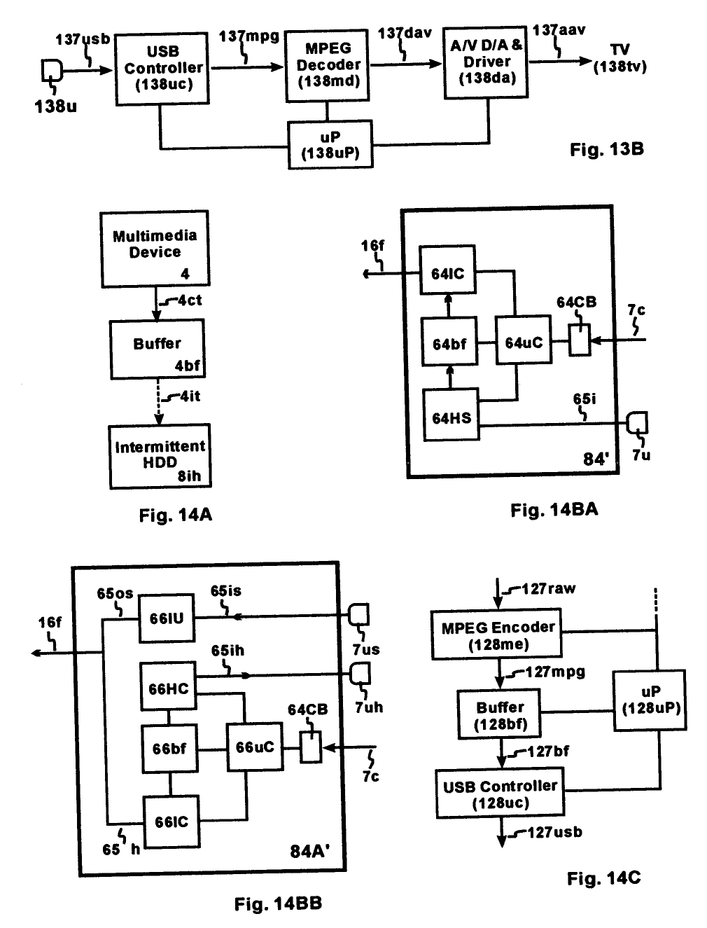

FIG. 2A illustrates a usage model for a preferred smart HDD (sHDD) 8 during communication with a multimedia device 4 (e.g. a digital camera 4c, a digital MP3 player 4p). This can be implemented by connecting these devices with an USB wire 8w1. In comparison, the prior art needs a host computer 2 to act as an intermediary (referring to FIG. 1A). In practice, the sHDD 8 can be used as a storage base for various types of multimedia data. For example, when the flash memory in the digital camera 4c is filled up, a user can download these digital photos from the digital camera 4c to the sHDD 8, thus emptying the flash memory space; or, when the user wants to listen to a new set of music, the user can upload these music files from the sHDD 8 to the digital MP3 player 4p. The sHDD 8 weighs under ˜170 g (referring to FIG. 16) and is palm-sized or smaller (referring to FIG. 16). Because no host computer is needed, the sHDD 8 offers true portability.

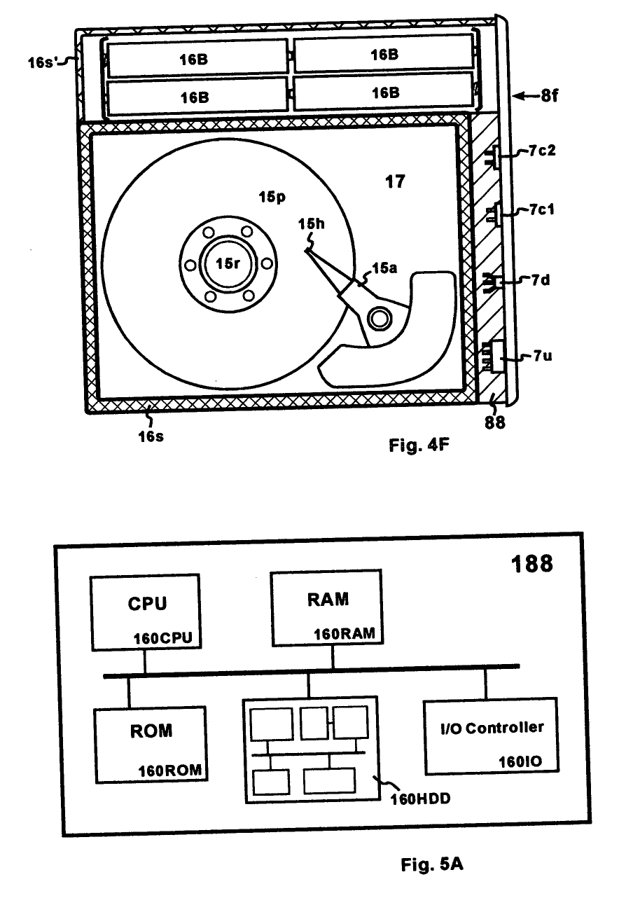

FIG. 2B is a perspective view of the sHDD 8. Its length, width and thickness are designated as L, W, T, respectively. It has a front panel 8f, a top cover 8t, a bottom (no shown), a left side 81, and a right side (not shown). Its front panel 8f comprises USB connector 7u, a display 7d, and a plurality of controls 7c. Optionally, the sHDD can further comprise a dc power input jack. More details about its front panels and user interfaces will be disclosed in FIGS. 8-10.

FIG. 2C illustrates a usage model for the sHDD 8 during communication with a host computer 2. The host computer 2, in general, has a larger HDD, more processing power and better connectivity (e.g. high-speed connection with the internet and optical drives). When the data in the sHDD 8 need to be uploaded to the host computer 2 or the data from the host computer 2 need to be fed into the sHDD 8, the sHDD 8 can be connected with the host computer 2 by an USB wire 8w2 and exchange data therewith. During this time, the sHDD 8 acts as a peripheral, while the host computers 2 as the host. The host computer 2 can also be used to manage the files in the sHDD 8.

Almost every multimedia device 4 in commercial use is based on the USB interface (in this disclosure, USB interface refers to any of USB 1.1, USB 2.0, IEEE 1394 and other interface protocols). To become backward compatible with these devices, the sHDD 8, when it acts as a host, preferably supports at least USB 1.1. On the other hand, when connected with a host computer 2 (as a peripheral), the sHDD 8 preferably supports USB and/or IEEE 1394 and/or other interface protocols. The data rates of USB 1.1, USB 2.0 and IEEE 1394 are 12 Mb/s, 480 Mb/s and 400 Mb/s, respectively.

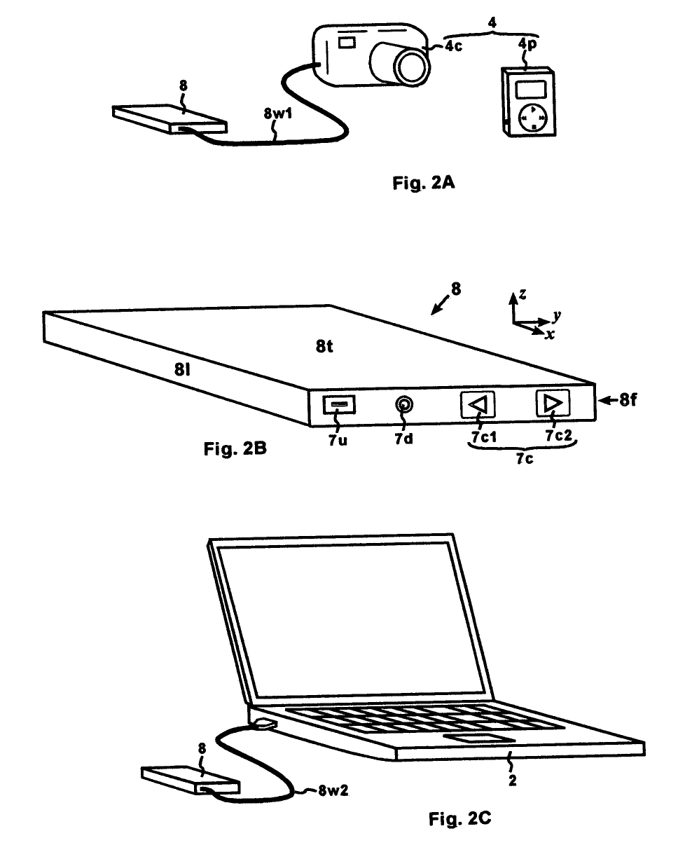

FIGS. 3AA-3AB illustrate a first preferred discrete sHDD with discrete IC's. FIG. 3AA is its plan view with the top cover 8t removed and its front panel pulled out. It comprises an enclosure 16′ that houses an off-the-shelf HDD 15 (based on the IDE interface 15m), a dual-role interface PCB 84 (which comprises an IDE interface 16f and an USB interface 7u) and a set of batteries 16B. In this preferred embodiment, the dual-role interface PCB 84 and the HDD PCB 80 (referring to FIG. 3B) are two separate PCB's. Accordingly, this sHDD 8 is referred to as discrete sHDD. The function of the dual-role interface PCB 84 is to convert the WDE interface 15m to the USB interface 7u and perform USB host/slave control. This preferred sHDD 8 includes four AAA batteries 16B. These batteries 16B power the sHDD 8 when it is in the host mode. Apparently, other custom battery may also be used.

FIG. 3AB is the block diagram of a preferred HDD PCB 80 and a first preferred dual-role interface PCB 84 with discrete IC's. The HDD PCB 80 should be apparent to those skilled in the art. It comprises a hard-disk controller (HDC) 60HC, μProcessor 60uC, buffer 60B, read channel 60RC and servo control 60SC. This preferred dual-role interface PCB 84 with discrete IC's comprises an analog control 64CB, μController 64uC, WDE controller 64IC, and host/slave controller 64HS. Among these, the analog control 64CB converts the analog control signals 7c to a digital form and feeds them to the μController 64uC. The μController 64uC may use 8051-family controller from a number of vendors. The IDE controller 64IC may be implemented by a simple buffer (e.g. 74LS245 from Philips) or through memory mapping using CPLD (e.g. XC95108 from Xilinx). The host/slave controller 64HS switches role of the sHDD 8 from the host to the slave or vice versa. With the advent of the USB on-to-go (USB OTG) technology, this task can be easily accomplished. It may use ISP1362 from Phillips or SL811HST from Cypress Semiconductor.

The discrete USB host/slave controller does not involve the design and making of a new IC. It has a short time-to-market and low cost. Thus, it is suitable for prototyping and small-volume production. When the customer demands increase, it is desirable to integrate these discrete components into a single chip. This can lower the system cost and reduce the system size. FIGS. 3BA-3BB illustrate a preferred integrated host/slave interface controller. FIG. 3BA is the plan view of the preferred dual-role interface PCB 84′. It comprises a single chip, i.e. integrated host/slave interface controller 64SC. It can perform the same functions as the preferred embodiment of FIG. 3AA. Referring now to FIG. 3BB, the block diagram of the integrated host/slave interface controller 64SC is illustrated. It comprises at least design blocks 641C (DE controller block), 64uC (micro-controller block) and 64HS (host/slave controller block).

In the preferred embodiments of FIGS. 3AA-3BB, the host/slave functions are performed by a single block—host/slave controller 64HS. Alternatively, the host/slave functions can be performed by separate blocks (or, data-paths), i.e. the host function is implemented by one set of chip(s); the slave function is implemented by another set of chip(s). This approach can take fill advantage of the advances made in the pHDD, i.e. at least the slave function can be implemented by a single chip (e.g. GL641USB, GL811USB from Genesys Logic) and in the slave mode, USB 2.0 is supported. The host function can be implemented in the standard way.

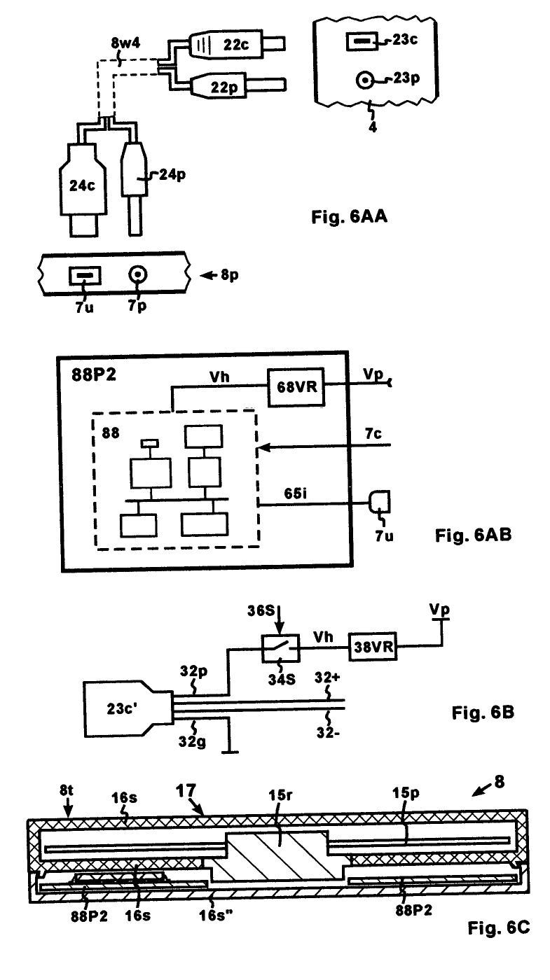

FIG. 3CA illustrates a discrete sHDD based on a first preferred separate data-path. This preferred dual-role interface PCB 84A uses two USB connectors (referring to FIG. 10A). In the slave mode, the type-B connector 7us is connected with a host computer. The data from the host computer 65is is converted into the WDE format 65os by the IDE-to-USB bridge chip 66IU. In the host mode, the type-A connector 7uh is connected with a multimedia device. The host controller 66HC, micro-controller 66uC and IDE controller 66IC converts the WDE data 65oh from the HDD to the USB format 65ih.

FIG. 3CB illustrates an alternate discrete sHDD based on a second preferred separate data-path. The preferred dual-role interface PCB 84B uses a hybrid USB connector (referring to FIG. 10B). The same data are fed into both the slave path and host path. By sensing the mode the sHDD is in, the control signals 7c, 66se selectively enable host path or slave path. The host data and slave data can be directly merged (FIG. 3CA). Alternatively, a bi-directional mux 65mx can used to select the desired data-path (FIG. 3CB).

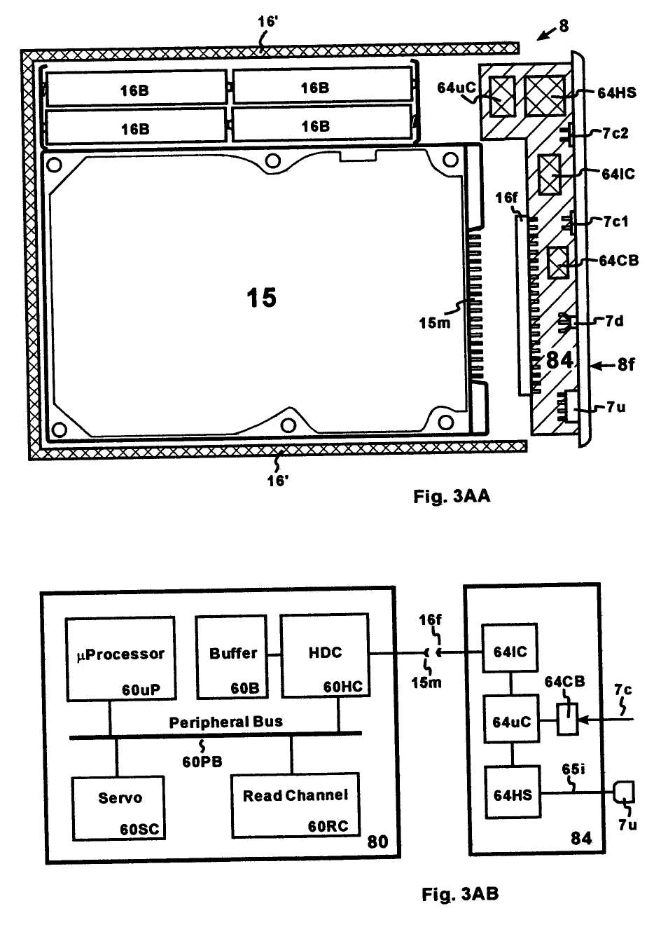

The pHDD 6 of FIG. 1 and the discrete SBDD 8 of FIG. 3 are both based on a traditional system partition originated from the computer age: the design of the HDD electronics is the responsibility of the HDD vendor (these HDD electronics are located on an HDD printed-circuit board, which is sealed inside an off-the-shelf HDD “box”); the design of the system electronics is the responsibility of the system manufacturer (these system electronics are located on a system motherboard, which communicates with the HDD through the WDE interface. From the system manufacturer's perspective, the off-the-shelf HDD is a “black box”). For the HDD-based portable electronic systems, this system partition is not ideal. To reduce size and lower cost, the present invention breaks the traditional design barrier and discloses a new design and business model—HDD integration. According to the HDD integration, at least a portion of the HDD electronics and system functions are integrated onto the same system motherboard (FIGS. 4A-4B). The sHDD 8 that utilizes the HDD integration is referred to as integrated sHDD. Apparently, the HDD integration can also be applied to the pHDD 6 of FIG. 1.

FIG. 4A is the block diagram of a first preferred integrated sHDD motherboard 86. It comprises two blocks: the HDD block 66a comprises the components from the HDD PCB 80; the interface block 66b comprises the components from the dual-role interface PCB 84. By integrating them on a single motherboard 86, the savings are apparent, i.e. at least one PCB (82 or 84) and two WDE connectors 15m, 16f can be saved. This reduces the system size and lowers the bill-of-materials.

It should be noted that, in FIG. 4A and the block diagrams thereafter, all blocks (e.g. host/slave controller 64HS) are design blocks. On the physical PCB, these blocks may be integrated into a single chip or partitioned into separate chips.

In FIG. 4A, the data 65ide from the HDD block 66a to the interface block 66b are in the IDE-format. With the HDD integration, there is no need to convert the data back and forth (i.e. from the USB-format 65i to the IDE-format 65ide and then from the WDE-format 65ide to the disk-format). Data can be straight converted from the USB-format to the disk-format. FIG. 4B illustrates a preferred implementation. Compared with FIG. 4A, the sHDD motherboard 88 comprises an extra host/slave disk controller 68HS (FIG. 4B) in place of the disk controller 60HC, IDE controller 64IC, μController 64uC and host/slave controller 64HS (FIG. 4A). This host/slave disk controller 68HS performs the USB host/slave function and also converts data from the USB-format to the disk-format.

FIG. 4C illustrates the detailed block diagram of a preferred host/slave disk controller 68HS. It comprises a host/slave controller 70HSC, a serial-interface engine (SIE) 70SIE, a processor interface 70PI, a buffer manager 70BM and a disk formatter 70DF. Its design is apparent to those skilled in the art.

FIG. 4D illustrates a preferred motherboard layout 88 corresponding to the block diagram of FIG. 4B. It comprises an integrated disk controller chip 68IA, a buffer chip 60B, an analog control chip 64CB, a servo control chip 60SC and a ROM chip 68ROM. Similar in design to CL-SH8665 from Cirrs Logic, the integrated disk controller chip 68IA comprises a μController block 60uC, a host/slave disk controller block 68HS and a read-channel block 60RC (referring to FIG. 4B). The motherboard 88 further comprises HDA interfaces such as servo interface 60SI and channel interface 60CI. These HDA interfaces provide electrical connections between the HDA 17 and the motherboard 88.

FIGS. 4E-4F illustrate the physical design of a preferred integrated sHDD. In the pHDD 6 of FIG. 1, the HDA 17 (e.g. platter 15p) is housed in two shells with mechanical strength 15e, 16: one shell 15e is from the off-the-shelf HDD 15 and the other is the system enclosure 16. In the integrated sHDD 8, the HDA 17 and motherboard 88 are housed in one integrated shell 16s: a portion of the integrated shell 16s houses the HDA 17, and the other portion houses the motherboard 88 and batteries 16B. Accordingly, after the removal of the top cover 8t, the platter 15p, rotor 15r, magnetic head 15h and arm 15a are revealed (FIG. 4F). Compared with the discrete sHDD of FIG. 3, the integrated sHDD is lighter and smaller.

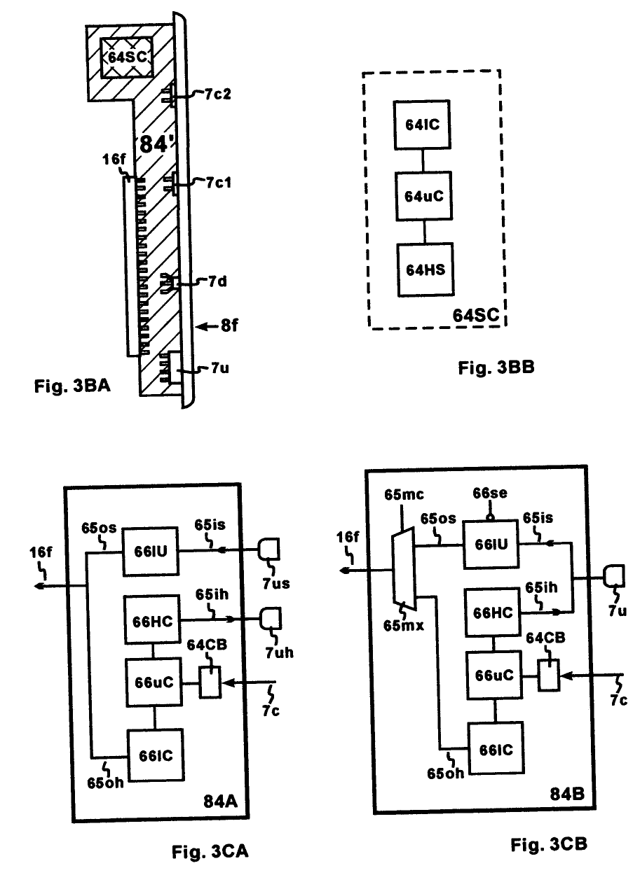

The HDD integration can be extended to other HDD-based portable systems. A key application is personal digital assistance (PDA). The off-the-shelf HDD is not suitable for the PDA. Accordingly, the existing PDA only uses solid-state memory (ROM, RAM) to store code and data. As a result, it has limited functionality. Through the HDD integration, i.e. integrating at least a portion of the HDD electronics onto the PDA motherboard, an HDD-based PDA (HDD-PDA) can be enabled. FIG. 5A is the block diagram of a preferred HDD-PDA motherboard 188. It comprises the HDD electronics 160HDD, CPU 160CPU, RAM 160RAM, ROM 160ROM, and I/O controller 160IO. The HDD can store multimedia files such as audio (e.g. music) and video (e.g. photo, video, GPS map); the RAM 160RAM works as a cache for the HDD; the ROM 160ROM stores software and data that need frequent access; the I/O controller 160IO controls HDD access and other I/O devices. Here, ROM 160ROM may use high-density ROM such as the three-dimensional read-only memory (3D-ROM). Similar to FIG. 4B, resources between the HDD electronics and system functions be shared. For example, the CPU 160CPU can be used to handle certain HDD tasks, and a portion of the RAM 160RAM can be used as the HDD buffer. FIG. 5B illustrates a preferred layout of the HDD-PDA motherboard 188. Note that the motherboard 188 also comprises a servo interface 60SI and a channel interface 60CI. FIGS. 5C-5D illustrate the physical design of a preferred HDD-PDA 9. This HDD-PDA 9 comprises a display 186, a plurality of controls 9c1-9c4, a motherboard 188 and an HDA 17. The motherboard 188 is located between the display 186 (on the top side 9t) and the BDA 17 (on the bottom side 9b).

One design philosophy of the sHDD is to make it simple. Instead of making it a computer-like device (which could cost ˜$500+ and hardly put into a pocket), preferably only bare-bone host function is designed in. This will result in a low-cost and reasonably sized sHDD. Accordingly, the present invention discloses a hybrid sHDD. It can utilize the battery, control and/or display of the multimedia device. FIG. 6 and FIG. 8 illustrate several preferred embodiments.

The battery set 16B in the sHDD 8 of FIG. 3 weighs ˜50 g (assuming four AAA batteries). This is about one-third of the overall sHDD weight. Since almost all multimedia devices contain batteries, it is desirable to use these batteries to power the sHDD. Accordingly, the sHDD does not have to carry heavy batteries to provide constant power (although it may carry bootstrapping batteries such as button cell batteries). This type of the sHDD is referred to as peripheral-powered sHDD (P²-sHDD). The P²-sHDD can be lighter and smaller than a self-powered sHDD (referring to FIGS. 3-4) by 30%. FIGS. 6AA-6D illustrate several preferred P2-sHDD's.

FIG. 6AA illustrates a preferred connection between a multimedia device 4 and a P2-sHDD 8. Besides the USB connector 23c, the multimedia device 4 has a power output jack 23p. In addition, the sHDD 8 has a power input jack 7p. On the peripheral side, the inter-device connection 8w4 has an USB plug 22c and a power plug 22p; on the SBDD side, it has an USB plug 24c and a power plug 24p. Note that the peripheral power supply Vp (from the multimedia device 4) may not exactly match the sHDD power supply Vh. Accordingly, the P2-sHDD motherboard 88P² preferably comprises a voltage regulator 68VR (FIG. 6AB). It converts the peripheral power supply Vp to the sHDD power supply Vh. Here, the HDD block 88 comprises the electronics contained on the motherboard 88 of FIG. 4B.

FIG. 6B illustrates an alternate preferred USB connector 23c′ used by the multimedia device 4. When a multimedia device 4 is connected to a P-sHDD, a host/slave control signal 36S is sent to the switch 34S and turns it on. Accordingly, the peripheral power supply Vp is sent to the sHDD through the wire 32p. Similarly, the sHDD power supply Vh is generated by a voltage regulator 38VR. Thus, no extra power jacks need to be added to the multimedia device 4 and the sHDD 8.

FIG. 6C illustrates a cross-sectional view of a preferred P²-sHDD 8. FIG. 6D is its plan view with the top cover removed. It comprises an HDA 17 and a motherboard 88P². Because it does not contain a battery set, a P²-sHDD 8 is similar in size to an off-the-shelf HDD 15.

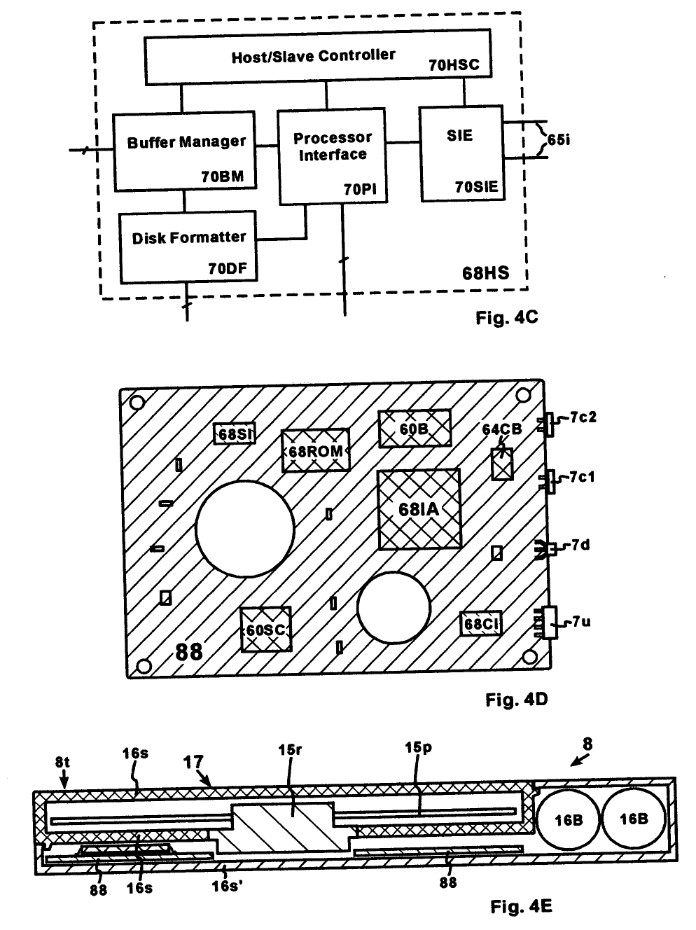

The sHDD provides a universal multimedia exchange platform. A single sHDD can be used to store and/or play-back all multimedia data from various multimedia sources, e.g. digital voice from a digital voice recorder, digital photos from a digital camera, digital videos from a digital camcorder, pre-recorded music for a MP3 player, pre-recorded movie for a DVD player. To facilitate their access, it is preferred to categorize multimedia files in the sHDD into different directories according to their sources. FIG. 7A illustrates a preferred directory structure at the sHDD root level 200r. Here, digital photos files are saved in the “photo” directory 200p; digital captured movies are saved in the “video” directory 200v; digital captured voices are saved in the “voice” directory 200rv; digital pre-recorded music files are saved in the “music” directory 200ms; digital pre-recorded movies are saved in the “movie” directory 200mv.

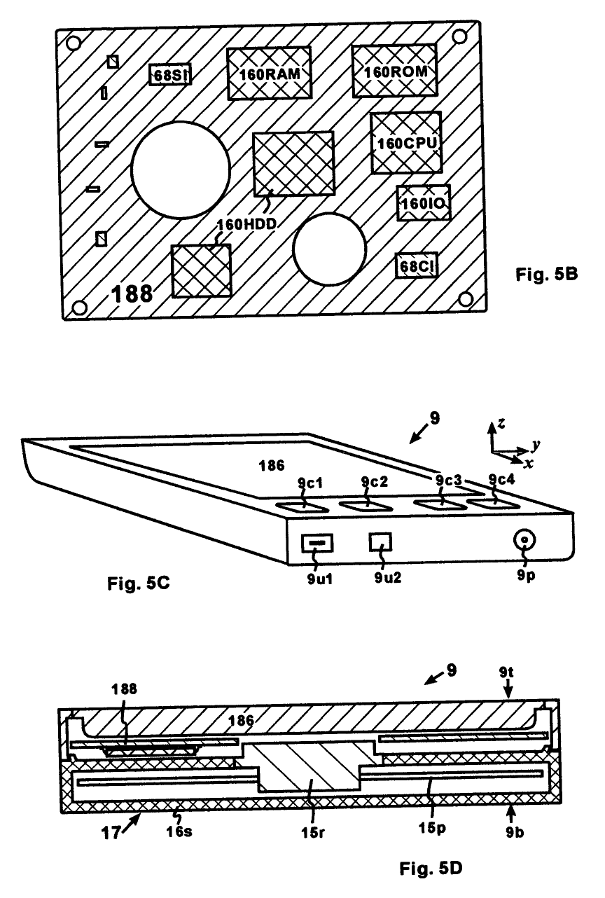

Because the sHDD has a large capacity (a 40 GB sHDD can store 20,000 6M Pixel photos, or 10,000 songs), each multimedia directory preferably has a hierarchy structure. FIG. 7B illustrates a preferred “music” directory 200ms. It comprises three levels, i.e. “music level I”, “music level II”, “music level 11I”. Each level has m, n, o sub-directories, respectively. For this preferred embodiment, m=n=o=10 and each sub-directory at “music level III” contain 10 songs. This file structure can simplify the upload process, as will become apparent when FIG. 9 and FIG. 10 are explained.

FIGS. 8A-8C illustrate three preferred controls on the sHDD front panel. The preferred embodiment of FIG. 8A comprises a screen 7d′ and four control buttons 7c1-7c4. The screen 7d′ displays the directory/file information; the control buttons 7c1-7c4 specify the targeted directory/file (i.e. the directory/file that data are downloaded to or uploaded from). The user may press the “A” button 7c4 or ‘V’ button 7c3 to change the directory level (referring to FIG. 7B); press the “<” button 7c1 or “>” button 7c2 to change the file/directory within the same directory level (referring to FIG. 7B); press and hold “ [symbol] ” button 7c4 to initiate the data upload, “ [symbol] ” button 7c3 to initiate the d download.

The preferred embodiment of FIG. 8B is simpler. It comprises a screen 7d′ and two control buttons 7c1-7c2. A user may browse through the directory/file within one directory level by pressing the “>” button 7c2; go down one directory level by pressing the “<” button 7c1; initiate the data upload by pressing and holding “ [symbol] ” button 7c4; initiate data download by pressing and holding the “ [symbol] ” button 7c1.

The preferred embodiment of FIG. 8C is a screen-less sHDD, i.e. it does not comprise a screen. As will be explained in more details in FIG. 9C, the display of the multimedia device can be used to display the directory/file information for the screen-less sHDD. A screen-less sHDD has an even lower hardware cost.

FIGS. 9A-9C illustrate several preferred data download and upload processes. FIG. 9A illustrates a preferred download process. Once the sHDD is connected with a multimedia device (e.g. a digital camera) (step 210da), the USB controller will enumerate and determine the device class of the digital camera (step 210db). Based on the device-class information, the sHDD will automatically select the “photo” directory. After the download key is pressed and held (step 210dc), data from the digital camera is then downloaded to said directory. The sHDD can automatically generate the sub-directory name based on information such as time stamp. Alternatively, the sub-directory name can be input from the digital camera.

FIG. 9B illustrates a preferred upload process. The upload process is slightly more complex than a download process. It requires the user to select from the file hierarchy the desired directory. In this preferred embodiment, a digital MP3 player is used as an example of the upload target. After the MP3 player is connected (step 210ua) and recogized (step 210ub), the user uses the control keys to select a sub-directory in the “music level I” (step 210uc, referring to the explanation of FIG. 8), then a sub-directory in the “music level II” (step 210ud), then a sub-directory in the “music level III” (step 210ue). Once the last hierarchy is reached, press and hold the upload key to initiate the data upload. This upload process can upload all files in a sub-directory, or, a single file.

For the screen-less SEDD, the details of the steps 210uc, 210ud, 210ue are illustrated in FIG. 9C. Whenever the “>” key is pressed (step 210uc1), a new sub-directory next to the one being displayed is selected. This information is pushed into the multimedia device and the display is updated (step 210uc2). Whenever the “<” key is pressed (step 210uc3), the sHDD will go down to the lower-level sub-directory (step 210uc4).

In combination of FIGS. 8-9, it becomes apparent to understand why the files in the sHDD are preferably organized in a hierarchy. This organization can minimize the number of times to press the control buttons before the desired sub-directory can be selected.

FIGS. 10A-10CB illustrates several preferred sHDD USB connectors. The preferred embodiment in FIG. 10A comprises a separate type-A receptacle 7u1 and type-B receptacle 7u2. It may use the standard USB wires for inter-device connection (i.e. the connection between the sHDD and a multimedia device; the connection between the sHDD and a host computer).

The preferred embodiment in FIGS. 10BA-10BC comprises a hybrid receptacle 7u. Referring now to FIG. 10BA, this hybrid receptacle 7u can be connected with both type-A (host) and type-B (peripheral) devices with the help of a hybrid USB wire 8w3 (FIG. 10BC). The switch 7cs is optional. It is turned on for the host mode and turned off for the slave mode. In the USB specification, type-A and type-B devices have different electrical connections: for type-A device, Pin-1 32p is connected with power supply V5 and Data+32+, Data-32— are connected to ground by 15 kohm pull-down resistors 38b, 38c; for type-B device, Pin-1 32p is floating and Data+32+is connected to V3 by a 1.5 kohm puff-up resistor 38a. Accordingly, a hybrid receptacle 7u needs to include switch circuits to re-configure the circuit when the sHDD changes its role (host⇄slave). FIG. 10BB illustrates a preferred configuration circuit. It comprises three switches 34a-34c. Among these, switches 34a, 34c are turned on when the host-control signals 36a, 36c are asserted; switch 34b is turned on when the slave-control signal 36b (the inverse of the host-control signal) is asserted. The host/slave-control signals 36a-36c can be controlled by the switch 7cs, or, can be set by automatically sensing the sHDD role. Referring now to FIG. 10BC, on the sHDD side, the hybrid USB wire 8w3 comprises a hybrid USB plug 28c; on the other side, it comprises a type-A plug 28cA and a type-B plug 28cB. The type-A plug 28cA is for the host computer 2, while the type-B plug 28cB is for the multimedia device 4.

For the preferred embodiments of FIGS. 10A-10BC, the USB wire (e.g. 8w3) and sHDD 8 are separate. In the portable world, the USB wire is preferably built into the sHDD 8. This offers better user-convenience, saves the number of connectors in the system and lowers the system cost. FIGS. 10CA-7CB illustrate a preferred sHDD with built-in USB wire 7w and a type-B plug 7m. FIG. 10CA is its front view and FIG. 10CB is its plan view along the cut-fine AA′. A slot 7s is formed on the front panel 8f and a USB plug 7m is hidden in said slot 7s. This USB plug 7m is connected with the sHDD motherboard through the USB wire 7w. In most portable applications, the sHDD needs to communicate with multimedia devices. Accordingly, the USB plug 7m is preferably a type-B mini-plug (to interface with a peripheral). When the sHDD needs to communicate with a host computer (through a regular type-A plug 7rm), a type-B-to-type-A adapter 7ad can be used, as is illustrated in FIG. 10CC.

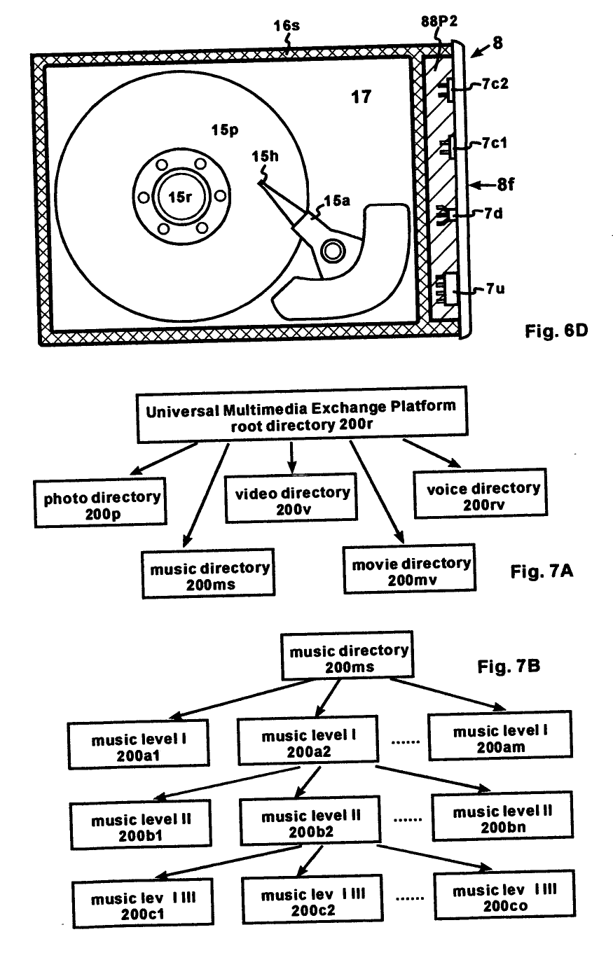

A careful study of a conventional HDD reveals that there is an empty space 16ur between the platter 15p and voice-coil motor 15v (referring to FIG. 11A). To fully utilize this space, the present invention discloses a compact HDD. FIGS. 11B-11F illustrate several preferred embodiments.

Referring now to FIG. 11B, a preferred compact HDD have an L-shaped HDD shell 16s, i.e. the width (W1) of the HDA shell 16s on one end is larger than its width (W2) on the other end. The open space 16urs of the “L” shape can be used to accommodate several other sHDD components. For the preferred embodiment of FIG. 11C, a retractable USB wire 7w is housed in this space 16urs; in FIG. 11D, a battery is placed in this space 16urs; in FIGS. 11EA-8EB (FIG. 11EA is the top view, FIG. 11EB is the cross-sectional view along the cut-line BB′), some HDD and/or system electronics are located in this space 16urs. Note the relatively large height of this space 16urs can be used to accommodate the stacking of several PCB's 88C1-88C3. These PCB's 88C1-88C3 can be connected by means such as flex-circuit 88f2.

Alternatively, the empty space 16ur of FIG. 1A can be directly used to house HDD electronics. For this preferred compact HDD, additional electronics 88C1 are housed inside the HDA shell 16s. They are connected with other HDD components through flex-circuit 88f1.

An HDD can be used to store digital captured videos from a digital camcorder. A 40 GB HDD can hold up to 20 hours of DVD-quality video, which is equivalent to the contents carried by 20 digital tapes. Their costs are comparable (the MiniDV or MICROMV tapes cost ˜$8 for each hour of digital video). Moreover, the random accessibility of the HDD can greatly simplify the video-editing process.

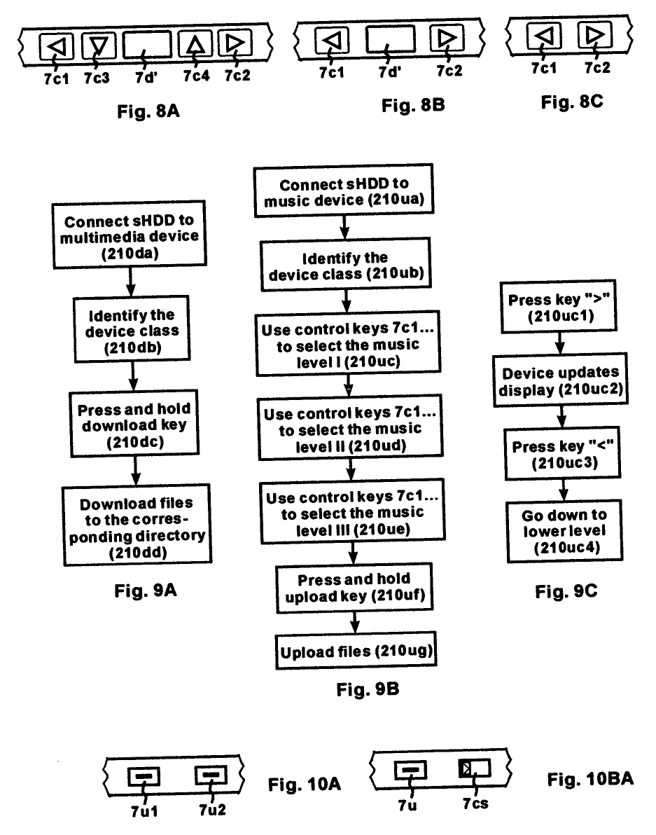

The present invention discloses an HDD-based camcorder. FIG. 12A is its side view and FIG. 12B is its back view. It comprises a lens 281, a viewfinder 28v, and a body 28b. It does not comprise a tape-drive but comprises (or can be connected with) an HDD. Accordingly, the video images are not stored in tapes or compact discs, but directly stored in the HDD. The HDD 8 is attached to the camcorder body 28b by a holding structure 28h. Depending on whether the camcorder provides host function, the HDD 8 can be sHDD or simply pHDD. It interfaces with the camcorder with an USB (or IEEE 1394, other interface protocols are also acceptable) connector 7m and a connection wire 7w. Because the HDD 8 preferably can be used in other applications (e.g. digital camera, digital MP3 player), it is preferably detachable from the camcorder body 28b. Alternatively, the HDD can be completed detached from the camcorder during usage and they are just connected by a connection wire 7w. FIG. 12C is the block diagram for said HDD-based camcorder. It comprises an image sensor 128 is, an MPEG encoder 128me, an USB controller 128uc and a microprocessor 128uP. The MPEG encoder 128me converts the raw video data 127raw to MPEG-format (i.e. DVD quality) 127mpg before sending it to the HDD in the USB format 127usb.

The HDD is an ideal storage media to store pre-recorded movies. A 40 GB HDD can store up to 20 hours of DVD movies. Considering the large base of installed TV's in hotels, it is certainly welcome by travelers to provide an inexpensive way to playback DVD movies on TV's in hotels. Accordingly, the present invention discloses a movie-playing apparatus. It converts the movie file from the HDD to the TV's AV signals and feeds them into a TV.

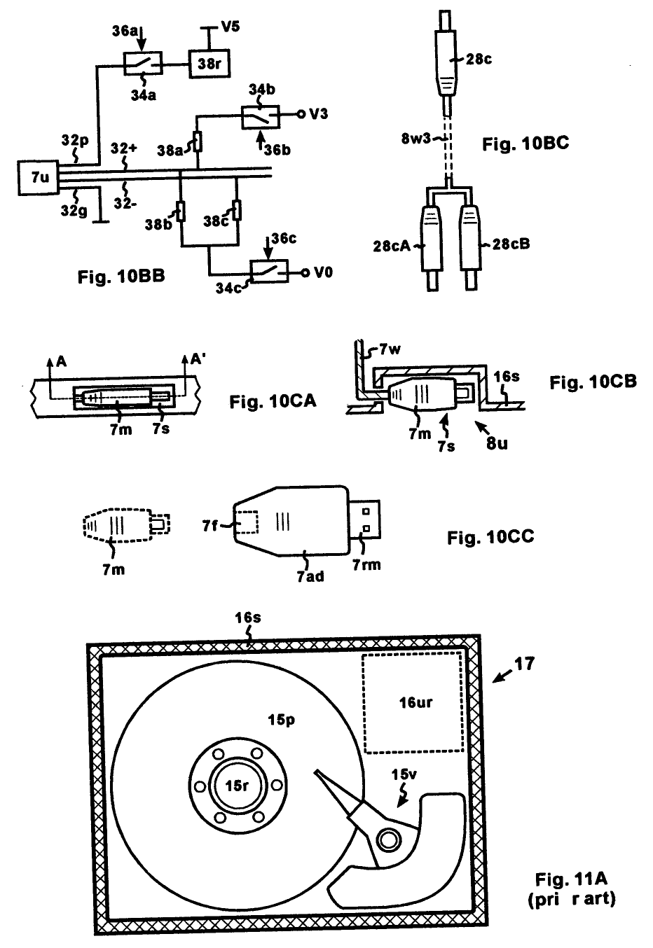

FIG. 13A is the plan view of the movie-playing apparatus 138. Besides a plurality of control buttons (as those on a DVD player), it comprises an USB port (or IEEE 1394) 138u, a set of composite (A/V) output jacks 138v, 138a (or an rf output). The USB port 138u receives data from the HDD (could be a sHDD or a pHDD, depending on if there is host function in the movie-playing apparatus 138). The video output jack 138v is connected with the video input of a TV; the audio output jack 138a is connected with the audio input of the TV. FIG. 13B is a block diagram of the movie-playing apparatus 138. It comprises an USB controller 138uc, an MPEG decoder 138md, an A/V D/A converter & driver 138da and a microprocessor 138uP. After the data 137usb are fed into the USB connector 138u, the USB controller 138uc converts them into MPEG data 137mpg, the MPEG decoder 138md further converts them into digital A/V signals 137dav; finally, the A/V D/A converter & driver 138da converts these digital signals into analog ones 137aav. These signals 137aav are fed into a TV 138tv and form the motion picture thereon.

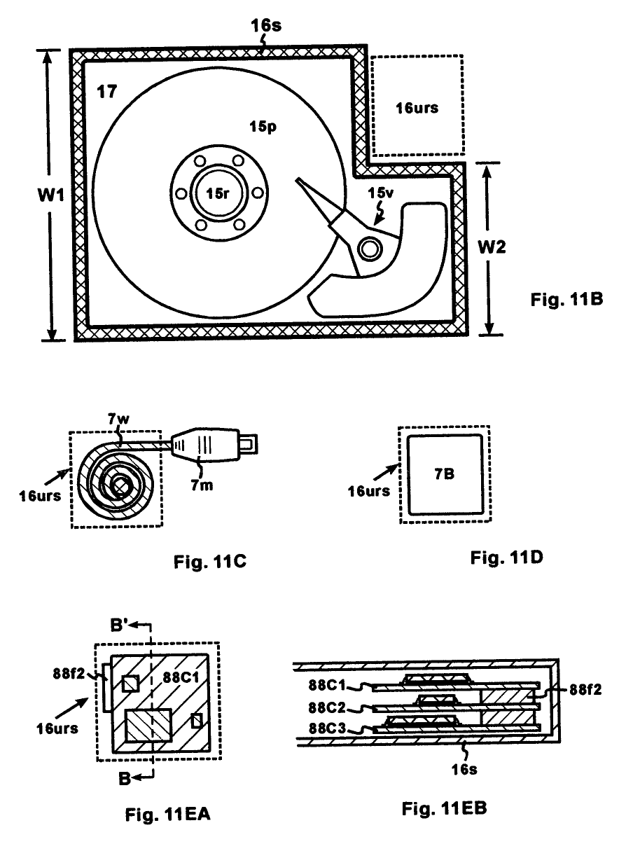

The HDD consumes relatively large power. To reduce power consumption, the present invention discloses two methods: one is intermittent HDD; the other is dual-speed HDD. FIG. 14A illustrates a preferred intermittent HDD 8ih. There is preferably a buffer memory 4bf in the system, i.e. either in the multimedia device 4 or in the sHDD 8. Only when this buffer memory 4bf is filled up will its contents be transferred to the HDD 8ih. Accordingly, this data transfer 4it is an intermittent process. It takes a short time and consumes little power.

In FIGS. 14BA-14BB, the buffer memory 64bf is included in the sHDD. FIG. 14BA illustrates a preferred discrete sHDD with discrete IC's and extra buffer memory 64bf. The buffer memory 64bf works as cache for the USB data 65i. FIG. 14BB illustrates a preferred discrete sHDD with separate data-path. The buffer memory 64bf is added to cache the USB data 65ih.

For the HDD-based camcorder and movie-playing apparatus, the video data rate (˜1 Mbyte/s) is much smaller than the data rate the HDD can handle. Accordingly, buffer memory can also be added to them. In FIG. 14C, a buffer memory 128bf is added in the HDD-based camcorder. It is inserted between the USB controller 12guc and the MPEG encoder 128me. In FIG. 14D, a buffer memory 13gbf is added to the movie-playing apparatus. It is inserted between the USB controller 138uc and the NDEG decoder 138md.

With the advent of the SBDD, the flash card in the multimedia devices becomes, in fact, a buffer memory. Because the HDD is non-volatile, there is no requirement on the non-volatility of the buffer memory. Accordingly, DRAM cards can be used as buffer memory in place of flash cards to store digital photos for digital cameras or digital music for MP3 players. FIGS. 14EA-14EB illustrate the design of a DRAM card 268bf. FIG. 14EA illustrates its form factor and FIG. 14EB is its block diagram. The DRAM card has the same size and interface as the flash card (e.g. CompactFlash or SmartMedia card). Internally, it comprises at least one DRAM chip 268dr and a controller chip 268ic. Because DRAM is less expensive than the flash, using the DRAM card can lower the system cost.

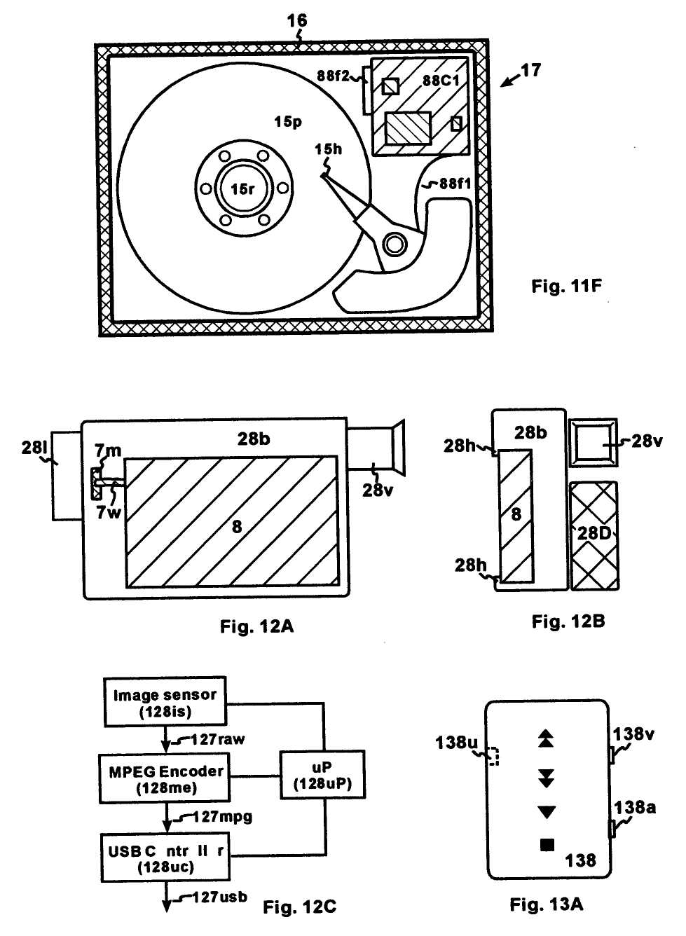

Alternatively, a dual-speed HDD can be used to reduce the power consumption. The dual-speed HDD can spin at two speeds: high speed (e.g. 5,400 rpm or higher) and low speed (e.g. several hundred rpm). When an HDD works in the USB 1.1 mode (data rate ˜12 Mb/s) or continuously stores the videos captured by a digital camcorder (data rate ˜4.7 Mb/s for the DVD-quality video), it only needs to spin at the low speed. This can significantly lower the power consumption. When the HDD works in modes such as USB 2.0 or IEEE 1394 (date rate ˜400 Mb/s), it switches to the full-speed mode. FIG. 15 illustrates a preferred servo control of a dual-speed HDD. It comprises two sets of servo controls 60SCF, 60SCS. To work in the high-speed mode, the mode-control signal 65hl enables the high-speed servo control 60SCF; to work in the low-speed mode, the mode-control signal 65hl enables the low-speed servo control 65SCS. Besides servo controls, the write/read circuitry may also need a low-speed version and high-speed version. They can be selectively enabled based on mode-control signal.

Referring now to FIG. 16, the dimension and weight of several preferred sHDD's are listed. This list includes 2.5″ and 1.8″ HDD. The 2.5″ sHDD's are typically wallet-sized and it can hold up to 30 GB of data (as of late 2002). The 1.8″ sHDD are typically credit-card-sized and it can hold up to 20 GB of data (as of late 2002). The retail price for a 10 GB 2.5″ sHDD will be ˜$150 and will eventually go down to ˜$70 (after the HDD integration). Its price/capacity ratio (˜$15/GB) is far better than the flash (˜$300/GB, as of late 2002). Accordingly, sHDD offers a convenient and inexpensive solution for multimedia storage.

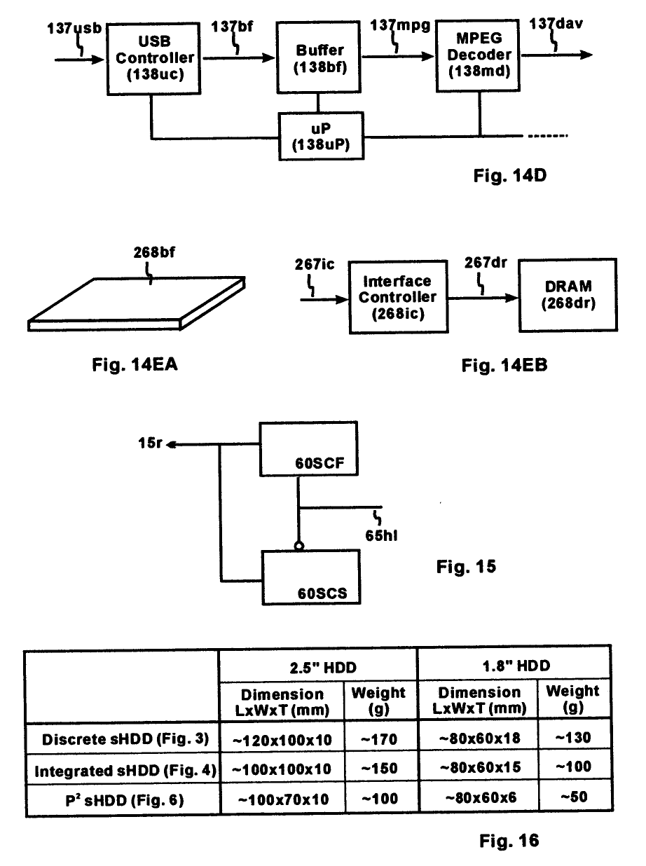

For users who already own a passive USB-based HDD 6, it is desirable to have a host apparatus that controls the file transfer between the passive HDD 6 and the multimedia device 4. FIG. 17 illustrates a preferred host apparatus 108 and its connections with a passive HDD 6 and a multimedia device 4. The host apparatus 108 connects with the passive HDD through a first USB interface 107; it also connects with the multimedia device 4 through a second USB interface. This second USB interface is similar to the USB interface 7u of the sHDD 8. The user interface of this host apparatus is also similar to that of the sHDD 8. Different from the sHDD 8, this host apparatus will only work in the host mode. For the slave mode, the user can simply connect the passive HDD directly with a computer and therefore, no host apparatus needs to be used.

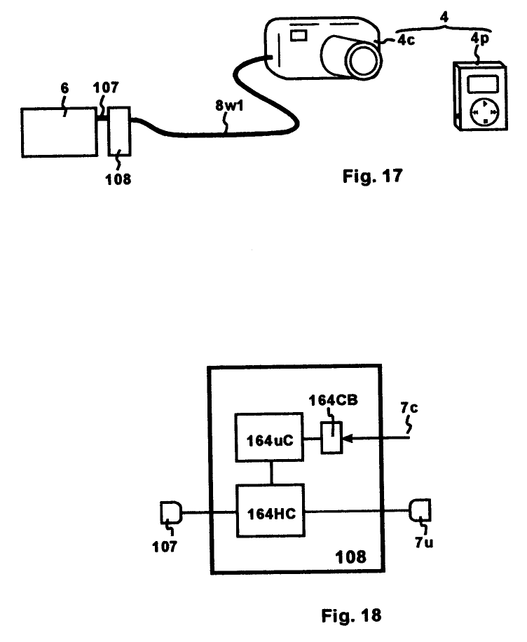

FIG. 18 illustrates a preferred implementation of a host apparatus 108. It comprises a host controller 164HC, a micro-controller 164uC and a control block 164CB. The micro-controller 164uC and control block 164CB are similar to those used in the sHDD 8. Since the host apparatus 108 only works in the host mode, the host controller 164HC can just comply with USB host spec. Optionally, it may also comply with the USB-On-The-Go spec. The host controller 164HC can comprise two USB interfaces 107, 7u; or, the host apparatus 108 can further comprise a USB hub chip (not shown in the figure). It should be noted that the host apparatus 108 also comprises a battery chamber, because it needs to supply power for file transfer.

While illustrative embodiments have been shown and described, it would be apparent to those skilled in the art that may more modifications than that have been mentioned above are possible without departing from the inventive concepts set forth therein. For example, the spirit of the present invention could be applied to other HDD interface standards to be adopted by the industry in the future. Moreover, the HDD integration of FIG. 4, HDD with built-in wire of FIG. 10C, compact HDD of FIG. 11, HDD-based camcorder of FIG. 12, HDD connected with the movie-playing apparatus of FIG. 13, power-saving methods of FIGS. 14-15 are also applicable to the off-the-shelf HDD and/or pHDD. The invention, therefore, is not to be limited except in the spirit of the appended claims.

What is claimed is:

1. A smart hard-disk drive (sHDD) system, comprising:
a head-disk assembly, said head-disk assembly further comprising at least a disk platter, at least a head and a rotor;
a first printed-circuit board, said printed-circuit board further comprising at least a portion of HDD electronics, whereby said HDD electronics control data communication and movement of said head-disk assembly; and
a host controller, whereby said host controller controls data communication of said sHDD system when said sHDD system is connected with an external multimedia device.

2. The SUDD system according to claim 1, wherein said host controller is a host/slave controller, said host/slave controller performing interface conversion when said sHDD system is connected with an external computer.

3. The smart hard-disk drive system according to claim 1, further comprising a USB or IEEE 1394 interface, said sHDD system communicating with said external multimedia device through said interface.

4. The sHDD system according to claim 1, further comprising a second printed-circuit board, wherein said host controller is located on said second printed-circuit board.

5. The sHDD system according to claim 1, wherein said host controller is located on said first printed-circuit board.

6. The sHDD system according to claim 1, wherein said host controller is integrated with said HDD electronics.

7. The sHDD system according to claim 1, wherein said host controller complies with USB host protocol.

8. The sHDD system according to claim 1, wherein said host controller complies with USB-On-The-Go protocol.

9. The SBDD system according to claim 1, further comprising at least one of the following elements:
A) a battery chamber;
B) a power input jack;
C) a hybrid receptacle;
D) a type-B plug;
E) a retractable connection wire.

10. The sHDD system according to claim 1, wherein said head-disk assembly further comprising a shell, said shell having a first width on one end and second width on the other end, said first width being larger than said second width.

11. The sHDD system according to claim 1, wherein the files and directories in said hard-disk drive are organized into a hierarchy structure.

12. A HDD-based portable electronic system, comprising:
a head-disk assembly (HDA), said HDA further comprising at least a disk platter, at least a head, and a rotor;
a printed-circuit board, said printed-circuit board further comprising at least an HDA interface, at least a portion of the HDD circuitry, and at least a portion of the system circuitry, wherein said HDA interface provides electrical connections between said HDA and said printed-circuit board.

13. The portable HDD-based electronic system according to claim 12, wherein said system circuitry comprises a host controller.

14. The portable HDD-based electronic system according to claim 12, further comprising only one shell with mechanical strength between said platter and at least one external surface of said portable system.

15. The portable electronic system according to claim 12, wherein said portable electronic system is an HDD-based personal digital assistance (HDD-PDA).

16. An HDD-based camcorder, comprising:
a holding structure, whereby a hard-disk drive can be attached to said camcorder by said holding structure; and
an interface, whereby said HDD-based camcorder can communicate with said hard-disk drive through said interface, and the videos captured by said hard-disk drive is stored to said hard-disk drive without first being stored on a tape or a compact-disc.

17. The HDD-based camcorder according to claim 16, further comprising a DRAM-based buffer memory.

18. The HDD-based camcorder according to claim 16, wherein the disk platter of said hard-disk drive is larger than 1.5″.

19. A host apparatus, comprising:
a first interface, whereby said first interface can be connected with a passive hard-disk drive;
a second interface, whereby said second interface can be connected with a multimedia device;
a host controller, whereby said host controller can control the data communication between said passive hard-disk drive and said multimedia device.

20. The host apparatus according to claim 19, wherein at least one of said first and second interfaces is a USB or IEEE 1394 interface.
